(19) United States
(12) Patent Application Publication
(10) Pub. No.: US 2026/0043524 A1
(43) Pub. Date: Feb. 12, 2026

(54) LOCKING FLOW AND PRESSURE SWITCH COVER

(71) Applicant: John R. Earle, Churchton, MD (US)

(72) Inventor: John R. Earle, Churchton, MD (US)

(21) Appl. No.: 18/980,049

(22) Filed: Dec. 13, 2024

Related U.S. Application Data
(60) Provisional application No. 63/682,146, filed on Aug. 12, 2024.

(51) Int. Cl. F17D 5/00; E05B 65/00

(52) U.S. Cl. CPC F17D 5/00; E05B 65/006

(57) ABSTRACT

Locking flow and pressure switch covers are configured to prevent unauthorized access to fluid flow or pressure switches in pressurized fluid delivery systems, particularly in industrial applications such as sprinkler systems. The invention addresses the problem of service personnel tampering with flow or pressure switches to avoid triggering alarms during maintenance, which can lead to significant damage and safety risks. The locking switch cover is configured to slide over the housing of a flow or pressure switch from either the top or bottom and can be secured with a locking bar and standard padlock. The cover ensures that the switch housing is fully enclosed, preventing unauthorized access and protecting the switch from damage. The cover uses a locking bar having a padlock receiver and tabs for easy manipulation. Also disclosed is a method for securing the switch using the cover and locking bar.

### CROSS-REFERENCE TO RELATED APPLICATIONS

This application is based upon and claims priority to U.S. Provisional Ser. No. 63/682,146 titled “Locking Flow and Pressure Switch Cover,” filed on Aug. 12, 2024 by the inventor herein, the specification of which is incorporated herein by reference in its entirety.

### FIELD OF THE INVENTION

The present invention relates to locks, and more particularly to locks for preventing the unauthorized access to covered fluid flow or pressure switches mounted to fluid supply lines, and methods of their use.

### BACKGROUND OF THE INVENTION

Pressurized fluid delivery systems are used in a wide variety of industrial applications. By way of non-limiting example, sprinkler systems are often installed in industrial buildings for fire protection purposes. Such sprinkler systems are often equipped with flow or pressure sensors positioned at various points in the distributed flow system, which sensors may automatically detect and generally manage the flow of fluid through the system and may initiate alarms in the event that a particular alarm event is triggered. For example, in the event of a fire at an industrial facility, the sprinkler system may be equipped with mechanisms that automatically detect the fire and automatically activate the sprinkler system. Flow or pressure sensors in the system may detect the increased fluid flow and may automatically signal an alarm to, for example, call the fire department or other personnel to combat the fire.

Such flow or pressure sensors typically comprise a switch having a water flow detector, which is an electro-mechanical device designed to send an alarm to a fire alarm panel and/or a fire department when a continuous flow of water occurs through the fire sprinkler system's piping as a result of an activated fire sprinkler head. A portion of an exemplary industrial sprinkler system is shown in FIG. 1, including a fluid riser 10 and a flow or pressure switch 20 positioned on the riser.

FIG. 2 is a close-up view of an exemplary flow or pressure switch 20 of traditional configuration, and includes a cover 22, a base 24, and a fluid line tap 26. The cover 22 may be attached to base 24 by screws or similar fasteners.

Such industrial fluid delivery systems require periodic maintenance. Unfortunately, there are service personnel that, from time to time when servicing such systems, interfere with the operation of the flow or pressure switches so as to ensure that an alarm condition is not triggered while they are performing their intended service. More particularly, as the flow or pressure switch 20 is typically connected to a supervised fire alarm or monitoring panel that automatically calls the fire department when activated, often service personnel attempt to disable the flow or pressure switches 20 so that they may perform the intended service without interference. Such service personnel may not have access to the fire alarm or monitoring panel, and may lack the knowledge or authority that would be required to temporarily disable the alarm (account numbers, passwords, etc.), but are nonetheless tasked with performing the needed service as quickly as possible.

It has become a not uncommon practice for certain service personnel to break off portions of the flow or pressure switch 20 assembly so as to be able to remove cover 22 from base 24, allowing access to the switch activator which they may then manually manipulate and block from moving. This allows the service personnel to drain and refill the sprinkler system without triggering an alarm. However, such practice creates multiple problems. First, damage done to remove cover 22 from base 24 results in cover 22 no longer fitting on base 24, or at a minimum not properly fitting on base 24, thus exposing switch 20 to weather, moisture, and the like.

Second, in order to repair such a damaged flow or pressure switch 20, the property owner or other responsible party is faced with an expense of potentially $500 per switch. Third, inoperative flow and pressure switches will fail to automatically dispatch the fire department in a fire emergency and could create a life threatening situation.

Previous efforts to prevent unauthorized access to flow or pressure switches on pressurized fluid delivery systems have been made. For example, U.S. Pat. No. 9,963,915 to Earle discloses a switch cable lock and method of use configured for securing the cover of a control switch with a locking cable system. However, such system leaves a significant portion of the control switch housing exposed, thus potentially inviting attempts at unauthorized access.

Thus, there remains a need in the art for a mechanism that will prevent unauthorized access to flow or pressure switches on pressurized fluid delivery systems, that is easy to install and remove, is of sufficiently simplistic construction to be manufactured at low cost so that it may be affordably deployed on systems having large numbers of such flow or pressure switches, and that blocks a significant portion of the switch housing from unauthorized access.

### SUMMARY OF THE INVENTION

The present invention provides a locking flow or pressure switch cover that is configured to easily slide over the housing of a flow or pressure switch from either the top or the bottom of the switch housing, offering versatility in the manner of installation and an adaptable configuration that may be chosen based on the surrounding physical environment of the flow or pressure switch. Once placed over the flow switch with a locking bar installed, any standard padlock may then be used to lock the flow switch cover in place. The locking bar may be inserted into the switch cover to lock the switch cover in place and to resist prying off of the cover for unauthorized access. Moreover, the locking bar forms a bottom support (or top wall) that will allow the installed flow switch cover to encompass the entirety of the flow switch housing, such that even if a portion of the flow switch housing is damaged during service or a screw is misplaced, the switch cover itself will hold the flow switch housing in place once installed. Still further, the locking bar positions a padlock, when installed, so that it is immediately visible to a person viewing the flow switch so that they are immediately informed that only authorized access is allowed. The switch cover employs a simple configuration that enables easy installation without need for a licensed contractor, is easily manufactured at minimal cost, and that nonetheless ensures significantly robust protection against unauthorized access to the flow or pressure switch.

In one aspect, the invention provides a locking flow or pressure switch cover comprising: a front plate configured to cover at least a portion of the front face of a flow or pressure switch; a first side plate and a second side plate extending from opposite sides of the front plate; a locking bar receiver flange extending from a rearward corner of each of the first side plate and the second side plate; at least one locking bar receiver in each locking bar receiver flange; an end plate extending between the first side plate and the second side plate and away from the front plate by a short distance along the length of each of the first side plate and the second side plate; and a back plate extending between the first side plate and the second side plate and away from the end plate by a short distance along the length of each of the first side plate and the second side plate, wherein the locking flow or pressure switch cover is configured to slide over a cover of the flow or pressure switch from either a top or a bottom of the cover, and wherein the locking flow or pressure switch cover is configured to receive a locking bar through a pair of aligned locking bar receivers and a padlock through the locking bar to secure the locking flow or pressure switch cover over the cover of the flow or pressure switch.

In another aspect, the invention provides a locking bar for use with a locking flow or pressure switch cover, the locking bar comprising: a padlock receiver positioned immediately adjacent to a distal end of the locking bar; locking bar tabs positioned at 90° to one another for easy manipulation of the locking bar; and a switch receiving seat extending along an inner corner of the locking bar enabling flush seating of the locking bar against a top or a bottom rear edge of a cover of a flow or pressure switch.

In yet another aspect, the invention provides a method of securing a flow or pressure switch, the method comprising: providing a locking flow or pressure switch cover comprising a front plate configured to cover at least a portion of the front face of a flow or pressure switch, a first side plate and a second side plate extending from opposite sides of the front plate, a locking bar receiver flange extending from a rearward corner of each of the first side plate and the second side plate, at least one locking bar receiver in each locking bar receiver flange, an end plate extending between the first side plate and the second side plate and away from the front plate by a short distance along the length of each of the first side plate and the second side plate, and a back plate extending between the first side plate and the second side plate and away from the end plate by a short distance along the length of each of the first side plate and the second side plate; providing a locking bar comprising a padlock receiver positioned immediately adjacent to a distal end of the locking bar, locking bar tabs positioned at 90° to one another for easy manipulation of the locking bar, and a switch receiving seat extending along an inner corner of the locking bar enabling flush seating of the locking bar against a top or a bottom rear edge of a cover of the flow or pressure switch; sliding the locking flow or pressure switch cover over the cover of the flow or pressure switch from either a top or a bottom of the cover; inserting the locking bar through a pair of aligned locking bar receivers in the locking bar receiver flanges; and inserting a padlock through the padlock receiver of the locking bar to lock the locking flow or pressure switch cover over the cover of the flow or pressure switch.

### BRIEF DESCRIPTION OF THE DRAWINGS

The numerous advantages of the present invention may be better understood by those skilled in the art by reference to the accompanying drawings in which:

FIG. 1 is a schematic view of a portion of an exemplary industrial sprinkler system including a fluid riser and a flow or pressure switch positioned on the riser.

FIG. 2 is a close-up view of an exemplary flow or pressure switch of traditional configuration.

FIG. 3 is a rear perspective view of a locking flow or pressure switch cover in accordance with certain aspects of an embodiment of the invention.

FIG. 4 is a front perspective view of the locking flow or pressure switch cover of FIG. 3.

FIG. 5 is a side view of the locking flow or pressure switch cover of FIG. 3, showing a lower pair of locking bar receivers.

FIG. 6 is a side view of the locking flow or pressure switch cover of FIG. 3, showing an upper pair of locking bar receivers.

FIG. 7 is a perspective view of the locking flow or pressure switch cover of FIG. 3 installed over a flow or pressure switch from the top of the switch housing.

FIG. 8 is a perspective view of the locking flow or pressure switch cover of FIG. 3 installed over a flow or pressure switch from the bottom of the switch housing.

FIG. 9 is a perspective view of the locking flow or pressure switch cover of FIG. 3 installed over a flow or pressure switch with a locking bar and a padlock.

FIG. 10 is a perspective view of the locking bar in accordance with certain aspects of an embodiment of the invention.

FIG. 11 is a side view of the locking bar of FIG. 10.

FIG. 12 is a top view of the locking bar of FIG. 10.

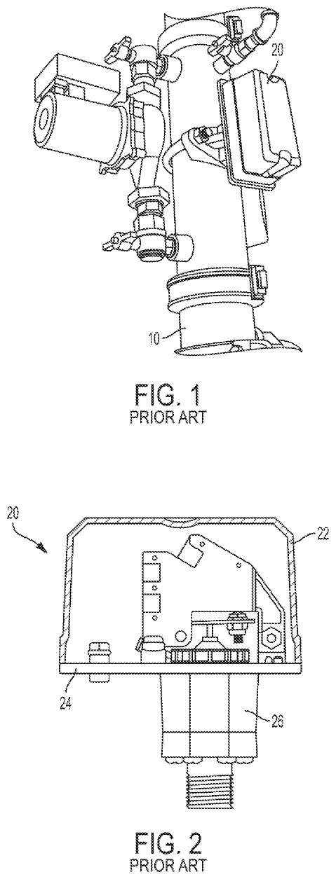

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

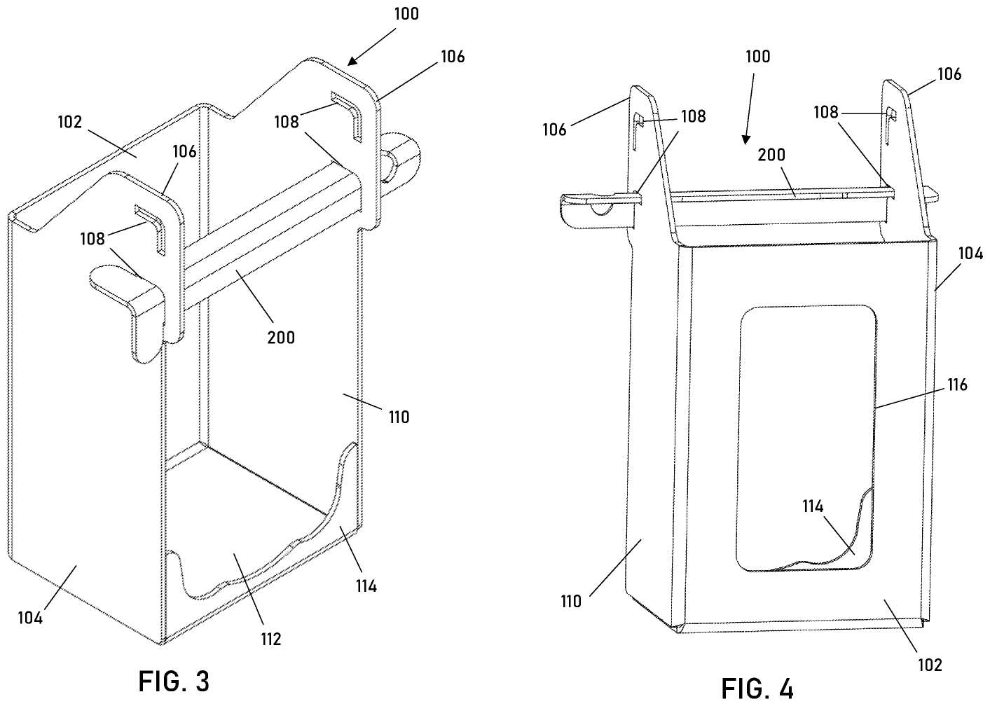

FIG. 3 shows a rear perspective view of a locking flow or pressure switch cover 100 in accordance with certain aspects of an embodiment of the invention. Locking switch cover 100 may be formed from a single, bended sheet of solid material, such as by way of non-limiting example a sheet of 14-gauge steel plate that will be difficult for a vandal to damage or remove when installed and locked on a water flow switch. Locking switch cover 100 is configured to easily slide over the housing of the water flow switch from either the top of the switch housing or the bottom of the switch housing, offering versatility in the manner of installation and an adaptable configuration that may be chosen based on the surrounding physical environment of the water flow switch. Once placed over the flow switch with a locking bar 200 installed, any standard padlock may then be used to lock the flow switch cover in place. The locking bar 200 may be inserted into switch cover 100 to lock the switch cover 100 in place and to resist prying off of the cover for unauthorized access. Moreover, the locking bar forms a bottom support (or top wall) that will allow the installed flow switch cover to encompass the entirety of the flow switch housing, such that even if a portion of the flow switch housing is damaged during service or a screw is misplaced, switch cover 100 itself will hold the flow switch housing in place once installed. Still further, the locking bar 200 positions a padlock, when installed, so that it is immediately visible to a person viewing the flow switch so that they are immediately informed that only authorized access is allowed. The switch cover 100 employs a simple configuration that enables easy installation without need for a licensed contractor, is easily manufactured at minimal cost, and that nonetheless ensures significantly robust protection against unauthorized access to the flow or pressure switch.

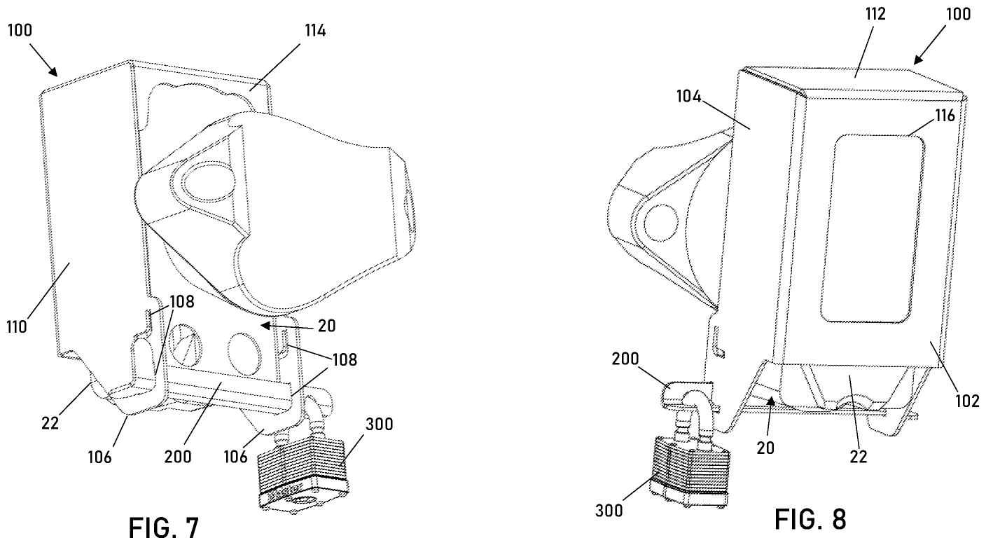

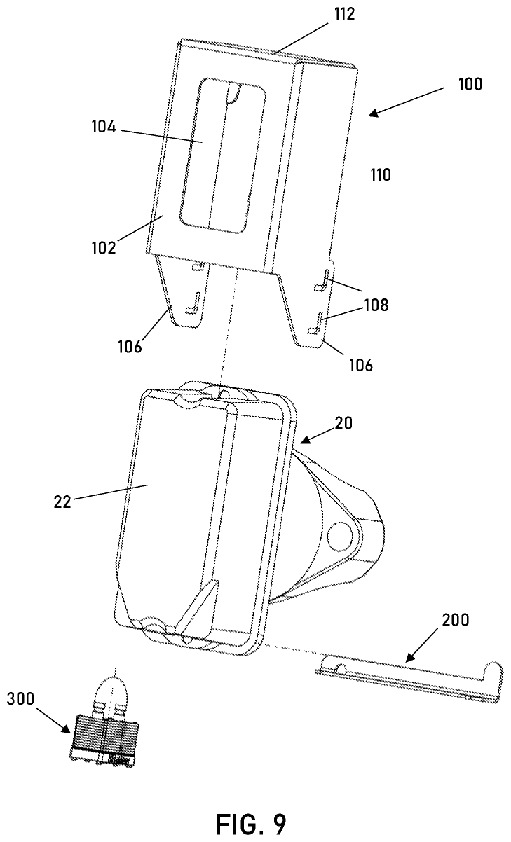

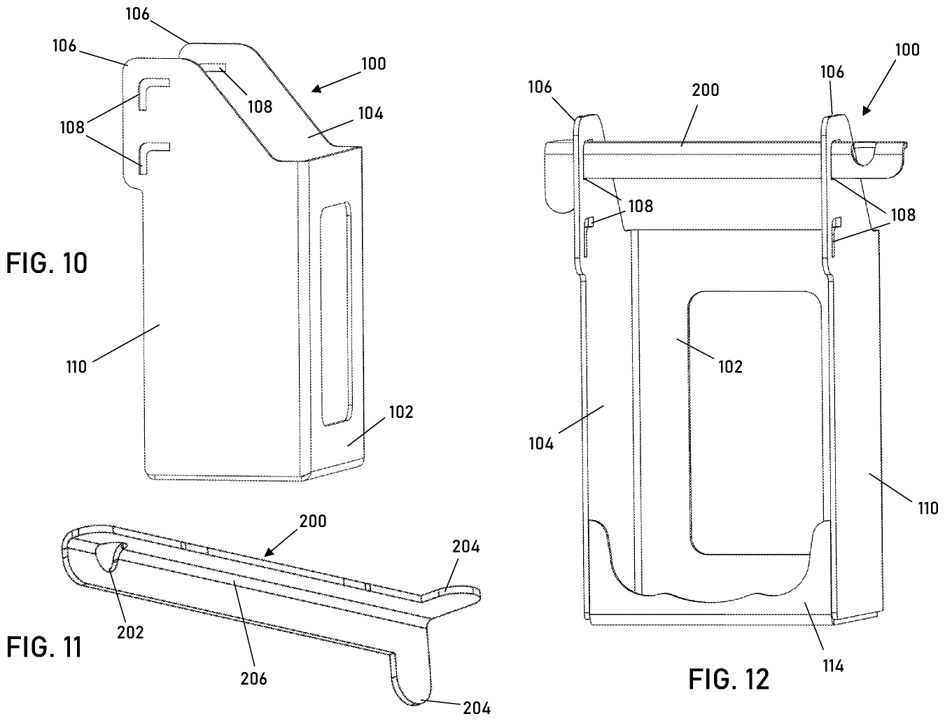

With continuing reference to FIG. 3 and the additional views of FIGS. 4-12, locking switch cover 100 comprises a front plate 102 configured to cover at least a portion of the front face of a flow or pressure switch 20 (FIGS. 7-9), a first side plate 104, a second side plate 110, a locking bar receiver flange 106 extending from a rearward corner of each of first side plate 104 and second side plate 110, at least one locking bar receiver 108 in each locking bar receiver flange 106, an end plate 112, and a back plate 114 that extends between first side plate 104 and second side plate 110 and away from end plate 112 by a short distance along the length of each of first side plate 104 and second side plate 110.

In an exemplary configuration, front plate 102 may include a window 116 allowing viewing of any indicia provided on the front of the cover 22 of switch 20 after locking switch cover 100 has been installed.

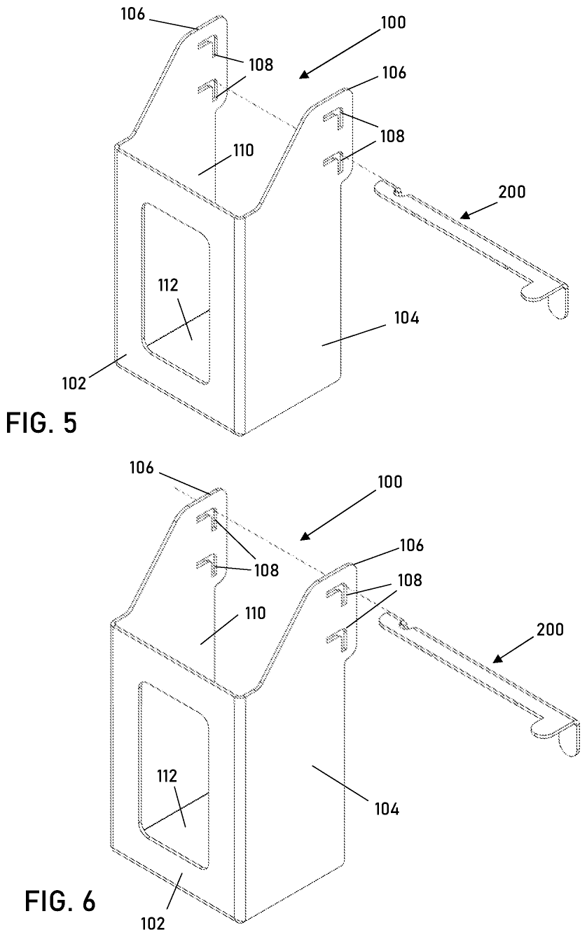

As shown in the Figures, in certain exemplary configurations each locking bar receiver flange 106 may include multiple locking bar receivers 108 to allow switch cover 100 to be installed and locked over flow and pressure switches having varying heights. Specifically and with particular reference to FIGS. 5 and 6, locking bar 200 may be inserted through aligned pairs of lower (FIG. 5) or upper (FIG. 6) locking bar receivers 108 to fit varying flow and pressure switch geometries.

Next and with particular reference to FIGS. 7-9, locking switch cover 100 may be easily installed over a flow or pressure switch 20 by simply aligning the open end of locking switch cover 100 over switch 20 so that font plate 102 is immediately adjacent to the front of cover 22, sliding locking switch cover 100 over the cover 22 of switch 20 until end plate 112 rests on cover 22, inserting locking bar 200 through locking bar receivers 108 aligned with the bottom, rear corner of switch 20, and inserting a padlock 300 through locking bar 200 to lock the assembly in place. In certain configurations, switch 20 may be located adjacent to obstructions that will make it difficult or impossible to place locking switch cover 100 from above, in which case locking switch cover 100 may be inverted and slid upward over switch cover 22 to avoid such obstructions. In this configuration, locking switch cover 100 is slid upward until end plate 112 contacts the bottom of switch 20, and locking bar 200 may be inserted through the locking bar receivers 108 that align with the top, rear corner of switch 20, after which padlock 300 may be inserted through locking bar 200 to lock the assembly in place.

FIG. 12 provides a detailed view of locking bar 200 that is particularly configured for ease of installation over switch 20, secure locking of switch 20, and positioning of a padlock 300 (or similar locking mechanism) with respect to switch 20 in a manner that immediately alerts passersby that access to the covered switch is prohibited.

In this regard, locking bar 200 includes a padlock receiver 202 positioned immediately adjacent to the distal end of locking bar 200, locking bar tabs 204 positioned at 90° to one another for easy manipulation of locking bar 200, and a switch receiving seat 206 extending along the inner corner locking bar 200 enabling flush seating of locking bar 200 against the top or bottom rear edges of the cover 22 of switch 20.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A locking flow or pressure switch cover comprising:
a front plate configured to cover at least a portion of the front face of a flow or pressure switch;
a first side plate and a second side plate extending from opposite sides of the front plate;
a locking bar receiver flange extending from a rearward corner of each of the first side plate and the second side plate;
at least one locking bar receiver in each locking bar receiver flange;
an end plate extending between the first side plate and the second side plate and away from the front plate along a short edge of each of the first side plate and the second side plate; and
a back plate extending between the first side plate and the second side plate and away from the end plate by a short distance along a length of each of the first side plate and the second side plate,
wherein the locking flow or pressure switch cover is configured to slide over a cover of the flow or pressure switch from either a top or a bottom of the cover, and
wherein the locking flow or pressure switch cover is configured to receive a locking bar through a pair of aligned locking bar receivers and a padlock through the locking bar to secure the locking flow or pressure switch cover over the cover of the flow or pressure switch.

2. The locking flow or pressure switch cover of claim 1, wherein the front plate comprises a window allowing viewing of any indicia provided on the front of the cover of the flow or pressure switch.

3. The locking flow or pressure switch cover of claim 1, wherein each locking bar receiver flange comprises multiple locking bar receivers to allow the locking flow or pressure switch cover to be installed and locked over flow or pressure switches having varying heights.

4. The locking flow or pressure switch cover of claim 1, wherein the locking bar comprises:
a padlock receiver positioned immediately adjacent to a distal end of the locking bar;
locking bar tabs positioned at 90° to one another for easy manipulation of the locking bar; and
a switch receiving seat extending along an inner corner of the locking bar enabling flush seating of the locking bar against a top or a bottom rear edge of the cover of the flow or pressure switch.

5. A locking bar for use with a locking flow or pressure switch cover, the locking bar comprising:
a padlock receiver positioned immediately adjacent to a distal end of the locking bar;
locking bar tabs positioned at 90° to one another for easy manipulation of the locking bar; and
a switch receiving seat extending along an inner corner of the locking bar enabling flush seating of the locking bar against a top or a bottom rear edge of a cover of a flow or pressure switch.

6. The locking bar of claim 5, wherein the locking bar is configured to be inserted through a pair of aligned locking bar receivers in locking bar receiver flanges extending from rearward corners of first and second side plates of the locking flow or pressure switch cover.

7. The locking bar of claim 5, wherein the locking bar is configured to receive a padlock through the padlock receiver to lock the locking flow or pressure switch cover over the cover of the flow or pressure switch.

8. A method of securing a flow or pressure switch, the method comprising:
providing a locking flow or pressure switch cover comprising a front plate configured to cover at least a portion of the front face of a flow or pressure switch, a first side plate and a second side plate extending from opposite sides of the front plate, a locking bar receiver flange extending from a rearward corner of each of the first side plate and the second side plate, at least one locking bar receiver in each locking bar receiver flange, an end plate extending between the first side plate and the second side plate and away from the front plate along a short edge of each of the first side plate and the second side plate, and a back plate extending between the first side plate and the second side plate and away from the end plate by a short distance along a length of each of the first side plate and the second side plate;
providing a locking bar comprising a padlock receiver positioned immediately adjacent to a distal end of the locking bar, locking bar tabs positioned at 90° to one another for easy manipulation of the locking bar, and a switch receiving seat extending along an inner corner of the locking bar enabling flush seating of the locking bar against a top or a bottom rear edge of a cover of the flow or pressure switch;
sliding the locking flow or pressure switch cover over the cover of the flow or pressure switch from either a top or a bottom of the cover;
inserting the locking bar through a pair of aligned locking bar receivers in the locking bar receiver flanges; and
inserting a padlock through the padlock receiver of the locking bar to lock the locking flow or pressure switch cover over the cover of the flow or pressure switch.

9. The method of claim 8, wherein the front plate of the locking flow or pressure switch cover comprises a window allowing viewing of any indicia provided on the front of the cover of the flow or pressure switch.

10. The method of claim 8, wherein each locking bar receiver flange of the locking flow or pressure switch cover comprises multiple locking bar receivers to allow the locking flow or pressure switch cover to be installed and locked over flow or pressure switches having varying heights.
